(19) United States
(12) Patent Application Publication
(10) Pub. No.: US 2001/0010054 A1
(43) Pub. Date: Jul. 26, 2001

(54) System, method and storage medium for distributing information useful in specific area to portable terminals

(76) Inventors: Naoyuki Orii, Tokyo (JP); Kazusui Hoshina, Tokyo (JP); Yoshitaka Yoshida, Tokyo (JP)

Correspondence Address: SUGHRUE, MION, ZINN, MACPEAK & SEAS, 2100 Pennsylvania Avenue, N.W., Washington, DC, 20037, US

(21) Appl. No.: 09/769,392

(22) Filed: Jan. 26, 2001

(30) Foreign Application Priority Data
Jan. 26, 2000 (JP) 17452/2000

(51) Int. Cl. G06F 15/16

(52) U.S. Cl. 709/201

(57) ABSTRACT

The invention enables business operators to boost their sales proceeds through increased selling and promotional opportunities, and at the same time powerfully supports customers' actions in a specific area. It also makes possible efficient selling and promotional activities and saves the customers the annoyance of receiving uninteresting information. First information useful in a specific area and its distributing time are registered in advance and, when the distributing time comes, the first information is distributed to a portable terminal of a customer perceived to be visiting the specific area. It is also made possible to distribute, out of the first information, only those items regarding which the attribute information of the spot requesting the distribution matches the preference information of the customer. Second information, differing from the first information, is distributed to portable terminals of customers not perceived to be visiting the specific area.

### BACKGROUND OF THE INVENTION

1. Field of the Invention

The present invention relates to a system, a method and a storage medium for enabling spots in a specific area to distribute information for mobilizing customers registered in advance to the customers' portable terminals.

2. Description of the Related Art

Conventional information distribution service in a specific area, such as a shopping mall or an amusement park, is designed to distribute information for mobilizing customers registered in advance by stores or attraction spots to all the customers irrespective of where the individual customers are, but no service to distribute special information to customers visiting the specific area (product information, inventory information, event information or the like useful at a particular time in the area) is available. Moreover, conventional information distribution service would indiscriminately distributes information registered in advance to all the customers, but there is no service to distribute only such information as is likely to interest individual customers.

Therefore, in a specific area, such as a shopping mall or an amusement park, the following problems would arise.

In a shopping mall, a first problem is that, even though a product desired by a customer is available at a store in the shopping mall, the customer, without knowing that, may give up buying that product. Second, it is impossible to hold an auction or the like solely for customers visiting the shopping mall to increase their shopping pleasure. These problems mean to store owners the disadvantage of reduced sales opportunities and accordingly reduced sales proceeds and, to shoppers, inability to quickly find what they want to buy and have to suffer inconvenience in shopping. Furthermore, where information is distributed to uninterested customers as in the conventional practice, it is not very likely for the customers to take the trouble of visiting the shopping mall, resulting in a further problem that the store owners are unable to carry out efficient sales activities and the customers are bored with uninteresting information distributed to them.

In an amusement park, there is a problem that customers may be obliged to spend a long time to find the attraction they want to watch or a toilet and, even if they find the attraction or a toilet, they may have to wait in a long queue if the place is congested. This problem means to the owner of the facility a slower turnover of the facility and accordingly a decrease in sales revenue from it. It means to the customers the disadvantage of inability to efficiently spend their time. Moreover, where information is distributed to uninterested customers as in the conventional practice, it is not very likely for the customers to take the trouble of visiting the amusement park, resulting in a further problem that the facility owners are unable to carry out efficient sales activities and the customers are bored with uninteresting information distributed to them.

### SUMMARY OF THE INVENTION

An object of the present invention, therefore, is to provide a system, a method and a storage medium for enabling business operators to boost their sales proceeds through increased selling and promotional opportunities by distributing information useful in a specific area to portable terminals and at the same time powerfully supporting customers' actions in the specific area.

Another object of the invention is to provide a system, a method and a storage medium for making possible efficient selling and promotional activities and at the same time for distributing to customers useful information in a specific area to their portable terminals without boring them.

According to an aspect of the present invention, there is provided a system for distributing information useful in a specific area to portable terminals, comprising: a means for perceiving a visit of the specific area by a customer; and a means for distributing first information useful in the specific area to a portable terminal of the customer perceived to be visiting the specific area.

According to another aspect of the invention, there is provided a system for distributing information useful in a specific area to portable terminals, comprising: a means for registering in advance first information useful in the specific area and its distributing time; a means for perceiving a visit of the specific area by a customer; and a means for distributing, when the distributing time comes, the first information to be distributed, to a portable terminal of the customer perceived to be visiting the specific area.

According to still another aspect of the invention, there is provided a system for distributing information useful in a specific area to portable terminals, comprising: a means for registering in advance first information useful in the specific area, its distributing time and attribute information regarding each spot requesting its distribution; a means for registering in advance preference information regarding each customer; a means for perceiving a visit of the specific area by a customer; and a means for distributing, when the distributing time comes, only the items regarding which the attribute information of the spot requesting the distribution matches the preference information of the customer, out of the first information to be distributed, to a portable terminal of the customer perceived to be visiting said specific area.

According to still another aspect of the invention, there is provided a method for distributing information useful in a specific area to portable terminals, comprising steps of: perceiving a visit of the specific area by a customer; and distributing first information useful in the specific area to a portable terminal of the customer perceived to be visiting the specific area.

According to still another aspect of the invention, there is provided a method for distributing information useful in a specific area to portable terminals, comprising steps of: registering in advance first information useful in the specific area and its distributing time; perceiving a visit of the specific area by a customer; and distributing, when the distributing time comes, only the items regarding which the attribute information of the spot requesting the distribution matches the preference information of the customer, out of the first information to be distributed, to a portable terminal of the customer perceived to be visiting said specific area.

According to still another aspect of the invention, there is provided a method for distributing information useful in a specific area to portable terminals, comprising steps of: registering in advance first information useful in the specific area, its distributing time and attribute information regarding each spot requesting its distribution; registering in advance preference information regarding each customer; perceiving a visit of the specific area by a customer; and distributing, when the distributing time comes, only the items regarding which the attribute information of the spot requesting the distribution matches the preference information of the customer, out of the first information to be distributed, to a portable terminal of the customer perceived to be visiting said specific area.

According to still another aspect of the invention, there is provided a storage medium recording thereon a program enabling a computer to execute: processing to perceive a visit of a specific area by a customer; and processing to distribute first information useful in the specific area to a portable terminal of the customer perceived to be visiting the specific area.

According to still another aspect of the invention, there is provided a storage medium recording thereon a program enabling a computer to execute: processing to register in advance first information useful in a specific area and its distributing time; processing to perceive a visit of the specific area by a customer; and processing to distribute, when the distributing time comes, the first information to be distributed, to a portable terminal of the customer perceived to be visiting said specific area.

According to still another aspect of the invention, there is provided a storage medium recording thereon a program enabling a computer to execute: processing to register in advance first information useful in a specific area, its distributing time and attribute information regarding each spot requesting its distribution; processing to register in advance preference information regarding each customer; processing to perceive a visit of the specific area by a customer; and processing to distribute, when the distributing time comes, only the items regarding which the attribute information of the spot requesting the distribution matches the preference information of the customer, out of the first information to be distributed, to a portable terminal of the customer perceived to be visiting said specific area.

### BRIEF DESCRIPTION OF THE DRAWINGS

These and other features and advantages of the invention will become more apparent from the detailed description hereunder, when taken in conjunction with the accompanying drawings, wherein:

FIG. 1 illustrates the overall configuration of a preferred embodiment of the invention;

FIG. 2 shows the contents of information stored in a database 30 in the embodiment of the invention;

FIG. 3 illustrates examples of information to be distributed by the embodiment of the invention; and

FIG. 4 illustrates an example of events as served by the embodiment of the invention.

### DETAILED DESCRIPTION OF THE PREFERRED EMBODIMENT

Next will be described in detail a preferred embodiment of the present invention with reference to the accompanying drawings.

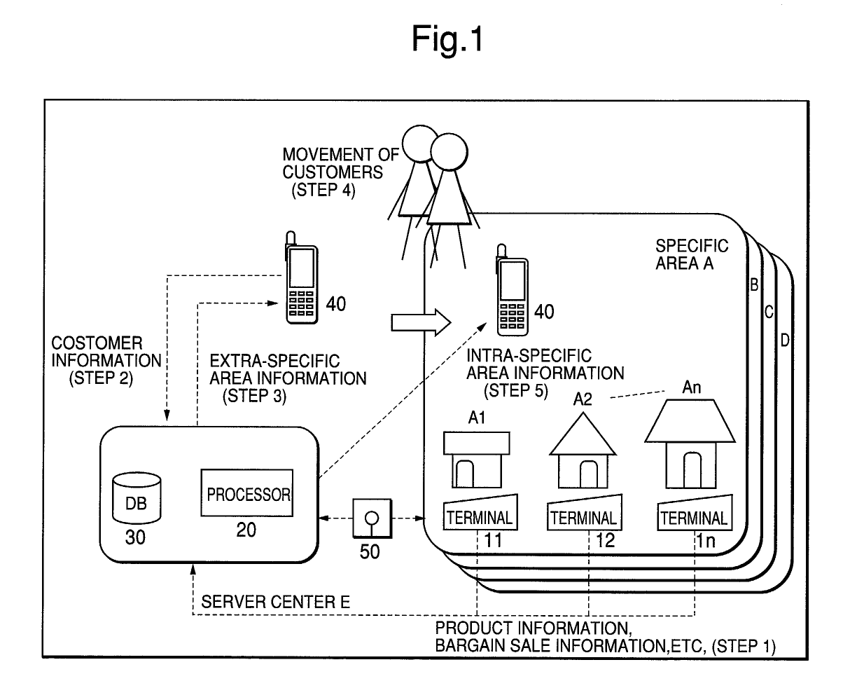

Referring to FIG. 1, the embodiment of the invention is applied for customer mobilization, product selling and/or service provision in specific areas A through D, which may be a shopping mall, an amusement park and the like. In the specific area A, there are arranged spots A1 through An, such as stores and the like if the specific area is a shopping mall, or attraction and the like if the specific area is an amusement park.

Similarly, in the specific areas B through D as well, spots B1 through Bn, C1 through Cn and D1 through Dn are arranged. Incidentally, although only four specific areas A through D are illustrated here, their number is not limited to this. There is also provided a server center E for registering information from the specific areas A through D and information from customers and distributing information to the customers, and this server center E is connected to the specific areas A through D by communication lines.

It being assumed that these facilities are available, the configuration of the embodiment of the invention when it is applied to the specific area A will be described below. In this case, this embodiment consists of terminals 11, 12, . . . , 1n installed at spots A1, A2, . . . , An, a processor 20 installed at the server center E, a database 30 also installed at the server center E, and portable terminals 40 borne by customers. Incidentally, the terminals 11, 12, . . . , 1n may be either personal computers installed at the spots or portable terminals borne by operators of spots. Since this embodiment distributes information to portable terminals 40 which the customers are well used to, the customers hardly need learning a new way of operation or making a new investment.

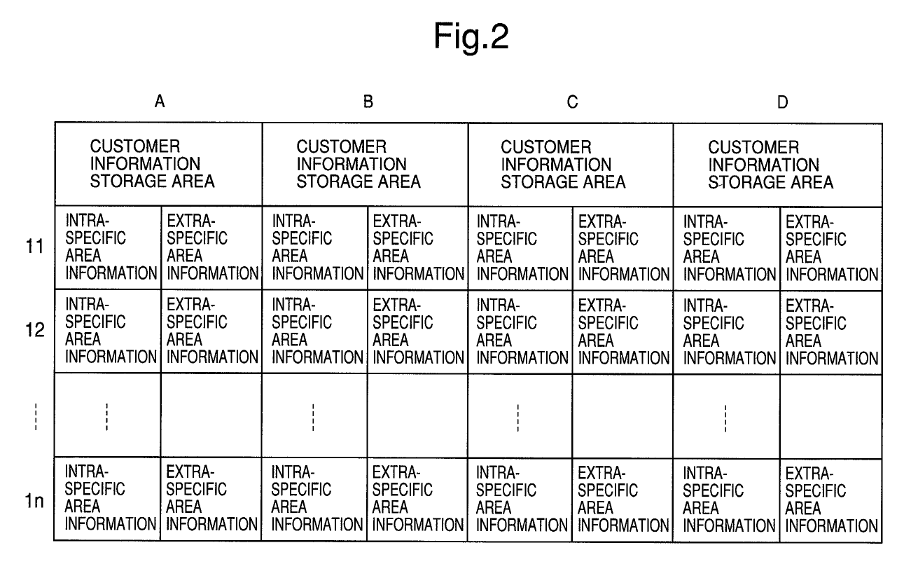

FIG. 2 illustrates an image of information stored in the database 30. The storage space of the database 30 is divided into areas for storing information regarding the specific areas A through D, and each area consists of a customer information storage area for storing information on customers registered as members of that specific area, an intra-specific area information storage area for storing information to be distributed to customers in the specific area (corresponding to “first information” in the claims; hereinafter to be referred to as “intra-specific area information”), and an extra-specific area information storage area for storing information to be distributed to customers outside the specific area (corresponding to “second information” in the claims; hereinafter to be referred to as “extra-specific area information”).

Next will be described the operation of the embodiment of the invention.

(Where the Specific Area is a Shopping Mall)

First, employees of stores A1 through An in the shopping mall A, using the terminals 11 through 1n, register member-customers of their respective stores with the server center E. Thus they transmit to the server center E such basic items of their store information (attribute information on their respective stores) as store names, brands they handle, locations and apparel styles they propose. Then the employees of the stores A1 through An, using the terminals 11 through 1n, transmits to the server center E such items of information to be distributed as store information, product information, inventory information, event information and the like together with their matching with information on the respective times due for distribution of these items of information. The processor 20 of the server center E registers these items of transmitted information into the database 30 (step 1).

The “information to be distributed” here, as stated above, may either be extra-specific area information useful for urging customers outside the shopping mall A to come shopping or intra-specific area information useful for urging customers within the shopping mall A to come shopping, and the two types of information are registered as differentiated from each other (see FIG. 2). The “information on the time due for distribution” may designate the time in one of many different ways including the day of the month at such and such hours and minutes, so many hours before the event the information refers to, and as soon as the pertinent information is registered into the database.

On the other hand, each customer registers in advance such items of information as his or her name, address, telephone number and preferences (e.g. favorite brand, color and dressing style). When instructed to register, the processor 20 at the server center E stores information on the customer into the customer information area of the shopping mall A in the database 30 (step 2).

Upon completion of the registration of these items, the processor 20 of the server center E distributes extra-specific area information stored in the database 30 to the portable terminals 40 of customers outside the shopping mall A (step 3). More specifically, it extracts the items of information to be transmitted at the current point of time, and distributes the information to other customers, out of the member-customers of the shopping mall A, than those whose visits to the shopping mall A have been informed at step 4, which is to be elaborated upon afterwards. If, when doing so, the processor 20 matches the basic information on stores having registered the pertinent items of information with customers' preference information and focuses on items likely to interest the respective customers, each customer will be saved the annoyance of receiving information not interesting to him or her. Furthermore, such a way of information supply tailored to each customer's particular needs would have the additional effects of increasing repeaters and intensifying the brand power penetration. The items of preference information may include not only those registered by customers in advance but also those automatically figured out from the product purchasing history of each customer at the shopping mall A.

Next will be described the operation that takes place when a customer has visited the shopping mall A.

Upon visiting the shopping mall A, the customer logs into the shopping mall A's exclusive home page via his or her portable terminal 40. This causes the processor 20 of the server center E to perceive that the customer is visiting the shopping mall A. Or the processor 20 of the server center E may perform automatic position detection utilizing the GPS function of the portable terminal 40, and perceive that the customer is visiting the shopping mall A (step 4). Then the processor 20 of the server center E informs the customer information storage area regarding the shopping mall A for that particular customer in the database 30, and afterwards distributes to the customer's portable terminals 40 intra-specific area information stored in the database 30 (step 5). More specifically, it extracts the items of information to be transmitted at the current point of time, and distributes those items to customers, out of the member-customers of the shopping mall A, those who have been perceived to be visiting the shopping mall A. If, on this occasion, the basic information on stores having registered the pertinent items of information is matched with the customers' preference information, and the items likely to interest the respective customers are focused upon, the customers will be saved the annoyance of receiving information not interesting to them. Furthermore, such a way of information supply tailored to each customer's particular needs would have the additional effects of increasing repeaters and intensifying the brand power penetration.

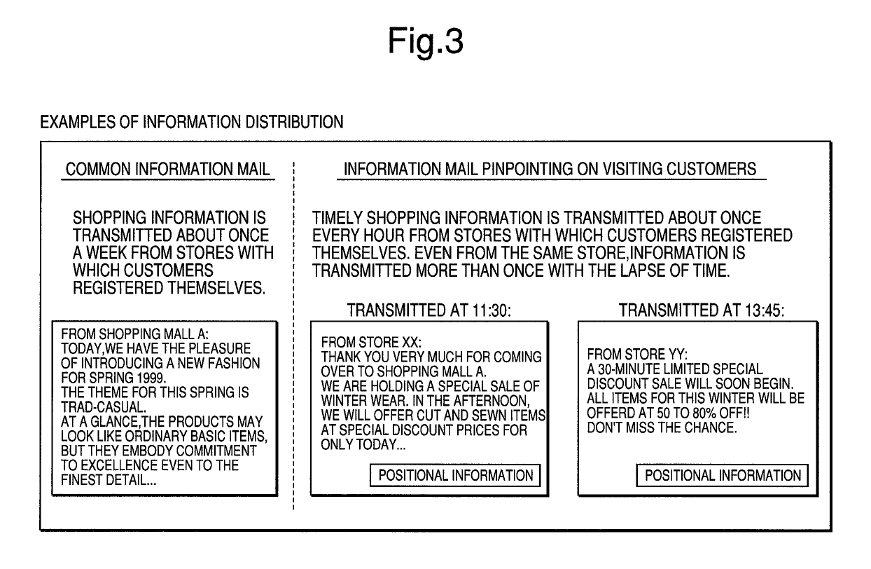

Hereupon, a common information mail (based on extra-specific area information) and an information mail pinpointing on visiting customers (based on intra-specific area information) are compared in FIG. 3. As illustrated in FIG. 3, the items of intra-specific area information comprising various items of service and event information that can be useful in that particular time span would be effective, and they may include more detailed product information (prices and stocked volumes of the respective products).

Furthermore, it is possible to use as required a configuration which would realize between the processor 20 and portable terminals 40 the optimal combination of color moving picture transmission/reception service, digital data transmission/broadcast service and music distributing service.

Although the information mail pinpointing on visiting customers as shown in FIG. 3 is a mere one-way notice to customers on a special sale or the like, it is also possible to enable each customer, looking at the information announced in the mail, to make an advance booking with each store to be visited using his or her portable terminal 40 and the store to confirm the booking to conclude transactions.

Furthermore, when a special event such as a bargain sale with time limits or an auction is held, customers can be enabled to participate in the event through their respective portable terminals 40.

Specific examples of such buyer-participating events will be described below.

(1) Bargain Sale

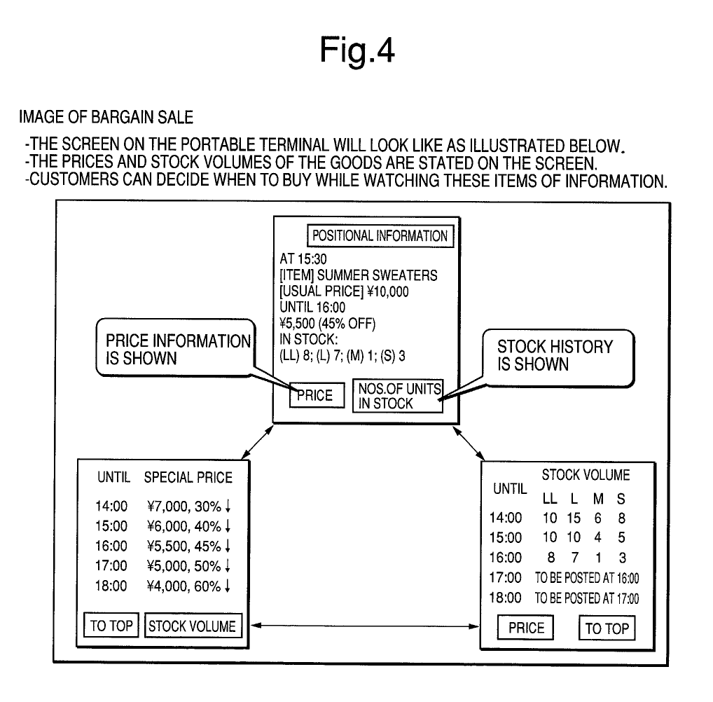

FIG. 4 illustrates how the announcement on a portable terminal 40 will look like when an apparel store offers a bargain sale of sweaters. The store intends to clear its stock of sweaters of four sizes. The prices of sweaters are set to be increasingly discounted with the lapse of time.

A customer having a portable terminal 40 checks in advance at the store what kinds of goods will be offered at bargain prices and, if any satisfactory item is found, can use the portable terminal 40 to know how much its price is being discounted and how many units of it are still remaining, determine the right time to buy, and book one. As the customer would visit the store to pick up the booked item, the store can attract more customers, who may buy other goods as well during the visit. The customer's travel to the store can be facilitated by knowing its location from simple map information or using the GPS function of the portable terminal 40 to determine the relative positions of his or her own and the store on a real time basis.

(2) Auction

This is an instance of auctioning a special item or a prestigious brand product. Each customer can continuously follow the progress of the auction, and make a bid through his or her portable terminal 40. As a successful bidder will directly visit the store to pick up the article, the store can expect to attract customers.

Incidentally, the processor 20 of the server center E can delete the information that a given customer has visited the shopping mall A by knowing that he or she returned home when the customer so logs into the shopping mall A's exclusive home page via his or her portable terminal 40 or it is so notified by the GPS function of the portable terminal 40, and thereafter resume distribution of extra-specific area information.

(Where the Specific Area is an Amusement Park)

First, attendants at attractions A1 through An installed in the amusement park A, using terminals 11 through 1n, register the respective attractions with the server center E. Thus, such basic items on each attraction as the type of attraction are transmitted to the server center E. Then, the attendants of the attractions A1 through An, using the terminals 11 through 1n, transmit to the server center E matching between the items of information to be distributed, including information on congestion, and information on the time due for distribution. The processor 20 of the server center E registers these transmitted items of information into the database 30 (step 1). The “information to be distributed” here, as stated above, may either be extra-specific area information useful for urging customers outside the amusement park A to come and enjoy the attraction or intra-specific area information useful for urging customers within the amusement park A to come and enjoy the attraction, and the two types of information are registered as differentiated from each other (see FIG. 2). The “information on the time due for distribution” may designate the time in one of many different ways including the day of the month at such and such hours and minutes, so many hours before the event the information refers to, and as soon as the pertinent information is registered into the database.

On the other hand, each customer registers in advance such items of information as his or her name, address, telephone number and preferences (e.g. favorite types of attraction). When instructed to register, the processor 20 at the server center E stores information on the customer into the customer information area of the amusement center A in the database 30 (step 2).

Upon completion of the registration of these items, the processor 20 of the server center E distributes extra-specific area information stored in the database 30 to the portable terminals 40 of customers outside the amusement park A (step 3). More specifically, it extracts the items of information to be transmitted at the current point of time, and distributes the information to other customers, out of the member-customers of the amusement park A, than those whose visits to the amusement park A have been informed at step 4, which is to be elaborated upon afterwards. If, when doing so, the processor 20 matches the basic information on attractions having registered the pertinent items of information with customers' preference information and focuses on items likely to interest the respective customers, each customer will be saved the annoyance of receiving information not interesting to him or her. Furthermore, such a way of information supply tailored to each customer's particular needs would have the additional effects of increasing repeaters and intensifying the brand power penetration.

Next will be described the operation that takes place when a customer has visited the amusement park A.

Upon visiting the amusement park A, the customer logs into the amusement park A's exclusive home page via his or her portable terminal 40. This causes the processor 20 of the server center E to perceive that the customer is visiting the amusement park A. Or the processor 20 of the server center E may perform automatic position detection utilizing the GPS function of the portable terminal 40, and perceive that the customer is visiting the amusement park A (step 4). Then the processor 20 of the server center E informs the customer information storage area regarding the amusement park A for that particular customer in the database 30, and afterwards distributes to the customer's portable terminals 40 intra-specific area information stored in the database 30 (step 5). More specifically, it extracts the items of information to be transmitted at the current point of time, and distributes those items to customers, out of the member-customers of the amusement park A, those who have been perceived to be visiting the amusement park A. If, on this occasion, the basic information on attractions having registered the pertinent items of information is matched with the customers' preference information, and the items likely to interest the respective customers are focused upon, the customers will be saved the annoyance of receiving information not interesting to them. Furthermore, such a way of information supply tailored to each customer's particular needs would have the additional effects of increasing repeaters and intensifying the brand power penetration. The items of preference information may include not only those registered by customers in advance but also those automatically figured out from the attraction attending history of each customer at the amusement park A.

To add, if intra-specific area information includes more detailed event information and items of information that can be useful only on that particular occasion, such as the degree of congestion at each attraction and restaurant, it can be even more effective.

The information mail to visiting customers can be more than a mere one-way notice to customers on the congestion at attraction sites of the like, and could enable each customer, looking at the information announced in the mail, to make an advance booking with the attraction site to be visited using his or her portable terminal 40 and enjoy the service at the attraction site after confirming the booking. In this way, the customer can effectively use his or her time without having to wait in a long queue. Similarly, it is conceivable to configure the system to make possible an advance booking with a restaurant or other facilities within the amusement park by utilizing the customer's portable terminal 40. If a special event, such as an auction, is held, the customer can participate in it through the portable terminal 40.

Furthermore, it is possible to use as required a configuration which would realize between the processor 20 and portable terminals 40 the optimal combination of color moving picture transmission/reception service, digital data transmission/broadcast service and music distributing service.

Incidentally, the processor 20 of the server center E can delete the information that a given customer has visited the amusement park A by knowing that he or she returned home when the customer so logs into the amusement park A's exclusive home page via his or her portable terminal 40 or it is so notified by the GPS function of the portable terminal 40, and thereafter resume distribution of extra-specific area information.

Also, referring back to FIG. 1, this embodiment of the invention may further include a storage medium 50. Here on the storage medium 50, there are stored either both or one of a program to cause the terminals 11 through 1n of the spots A1 through An to execute the above-described processing and another program to cause the processor 20 of the server center E to execute the above-described processing. Each of the terminals 11 through 1n and the processor 20 perform similar processing to what was described above under the control of the program loaded from the storage medium 50. In this case, the program may as well be loaded from the storage medium 50 via a signal line. The storage medium 50 may be a magnetic disk, a semiconductor memory or any other appropriate storage medium, and the program may be divided to store each divided segment on one or another of a plurality of grouped storage media.

Although in the above described embodiment of the invention information from a plurality of specific areas A through D is collectively registered in the database 30 of the server center E, it may as well be registered in a database provided for each specific area. This configuration would permit information to be augmented with the attributes of the pertinent specific area when it is distributed, so that the effect to attract customers to the specific area can be further enhanced.

As hitherto described, this embodiment, as it distributes different information from what is usually distributed to customers outside a specific area to portable terminals of customers visiting the specific area, provides the benefits of enabling business operators to earn more sales proceeds through increased selling and promotional opportunities and powerfully supporting customers' activities in the specific area.

Furthermore, this embodiment, as it distributes information on spots to customers' portable terminals only when the spots fit the pertinent customers' preferences, provides the benefits of making possible efficient selling and promotional activities and saving the customers the annoyance of receiving information uninteresting to them.

What is claimed is:

1. A system for distributing information useful in a specific area to portable terminals, comprising:
a means for perceiving a visit of the specific area by a customer; and
a means for distributing first information useful in the specific area to a portable terminal of the customer perceived to be visiting the specific area.

2. A system for distributing information useful in a specific area to portable terminals, comprising:
a means for registering in advance first information useful in the specific area and its distributing time;
a means for perceiving a visit of the specific area by a customer; and
a means for distributing, when the distributing time comes, the first information to be distributed, to a portable terminal of the customer perceived to be visiting the specific area.

3. A system for distributing information useful in a specific area to portable terminals, comprising:
a means for registering in advance first information useful in the specific area, its distributing time and attribute information regarding each spot requesting its distribution;
a means for registering in advance preference information regarding each customer;
a means for perceiving a visit of the specific area by a customer; and
a means for distributing, when the distributing time comes, only the items regarding which the attribute information of the spot requesting the distribution matches the preference information of the customer, out of the first information to be distributed, to a portable terminal of the customer perceived to be visiting said specific area.

4. A system, as claimed in claim 1, wherein:
second information, differing from said first information, is distributed to portable terminals of customers not perceived to be visiting said specific area.

5. A system, as claimed in claim 1, wherein:
said specific area is a shopping mall, said first information concerns an event, and customers are enabled to participate in the event by responding through said portable terminals.

6. A system, as claimed in claim 1, wherein:
said specific area is an amusement park, said first information concerns congestion at an attraction site, and customers are enabled to book for participation in the pertinent attraction through said portable terminals.

7. A method for distributing information useful in a specific area to portable terminals, comprising steps of:
perceiving a visit of the specific area by a customer; and
distributing first information useful in the specific area to a portable terminal of the customer perceived to be visiting said specific area.

8. A method for distributing information useful in a specific area to portable terminals, comprising steps of:
registering in advance first information useful in the specific area and its distributing time;
perceiving a visit of the specific area by a customer; and
distributing, when the distributing time comes, the first information to be distributed, to a portable terminal of the customer perceived to be visiting said specific area.

9. A method for distributing information useful in a specific area to portable terminals, comprising steps of:
registering in advance first information useful in the specific area, its distributing time and attribute information regarding each spot requesting its distribution;
registering in advance preference information regarding each customer;
perceiving a visit of the specific area by a customer; and
distributing, when the distributing time comes, only the items regarding which the attribute information of the spot requesting the distribution matches the preference information of the customer, out of the first information to be distributed, to a portable terminal of the customer perceived to be visiting said specific area.

10. A method, as claimed in claim 7, wherein:
second information, differing from said first information, is distributed to portable terminals of customers not perceived to be visiting said specific area.

11. A method, as claimed in claim 7, wherein:
said specific area is a shopping mall, said first information concerns an event, and customers are enabled to participate in the event by responding through said portable terminals.

12. A method, as claimed in claim 7, wherein:
said specific area is an amusement park, said first information concerns congestion at an attraction site, and customers are enabled to book for participation in the pertinent attraction through said portable terminals.

13. A storage medium recording thereon a program enabling a computer to execute:
processing to perceive a visit of a specific area by a customer; and
processing to distribute first information useful in the specific area to a portable terminal of the customer perceived to be visiting the specific area.

14. A storage medium recording thereon a program enabling a computer to execute:
processing to register in advance first information useful in a specific area and its distributing time;
processing to perceive a visit of the specific area by a customer; and
processing to distribute, when the distributing time comes, the first information to be distributed, to a portable terminal of the customer perceived to be visiting said specific area.

15. A storage medium recording thereon a program enabling a computer to execute:
processing to register in advance first information useful in a specific area, its distributing time and attribute information regarding each spot requesting its distribution;
processing to register in advance preference information regarding each customer;
processing to perceive a visit of the specific area by a customer; and
processing to distribute, when the distributing time comes, only the items regarding which the attribute information of the spot requesting the distribution matches the preference information of the customer, out of the first information to be distributed, to a portable terminal of the customer perceived to be visiting said specific area.

16. A storage medium as claimed in claim 13, wherein:
said program causes a computer to execute processing to distribute second information, differing from said first information, to portable terminals of customers not perceived to be visiting said specific area.

17. A storage medium as claimed in claim 13, wherein:
said specific area is a shopping mall, said first information concerns an event, and said program causes a computer to execute processing to enable customers to participate in the event by responding through said portable terminals.

18. A storage medium as claimed in claim 13, wherein:
said specific area is an amusement park, said first information concerns congestion at an attraction site, and said program causes a computer to execute processing to enable customers to book for participation in the pertinent attraction through said portable terminals.

19. A plurality of grouped storage media wherein said program claimed in claim 13 is divided into a plurality of segments, and each divided segment is recorded on one or another of said plurality of storage media.

20. A program embodied in electrical signals, said program enabling a computer to execute:
processing to perceive a visit of a specific area by a customer; and
processing to distribute first information useful in the specific area to a portable terminal of the customer perceived to be visiting the specific area.

21. A program embodied in electrical signals, said program enabling a computer to execute:
processing to register in advance first information useful in a specific area and its distributing time;
processing to perceive a visit of the specific area by a customer; and
processing to distribute, when the distributing time comes, the first information to be distributed, to a portable terminal of the customer perceived to be visiting said specific area.

22. A program embodied in electrical signals, said program enabling a computer to execute:
processing to register in advance first information useful in a specific area, its distributing time and attribute information regarding each spot requesting its distribution;
processing to register in advance preference information regarding each customer;
processing to perceive a visit of the specific area by a customer; and
processing to distribute, when the distributing time comes, only the items regarding which the attribute information of the spot requesting the distribution matches the preference information of the customer, out of the first information to be distributed, to a portable terminal of the customer perceived to be visiting said specific area.
